(19) United States
(12) Patent Application Publication
(10) Pub. No.: US 2009/0226074 A1
(43) Pub. Date: Sep. 10, 2009

(54) Surface area estimation of a coating defect

(75) Inventor: Brian K. London, Chaplin, CT (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: United Technologies Corporation, Hartford, CT (US)

(21) Appl. No.: 12/074,401

(22) Filed: Mar. 4, 2008

(51) Int. Cl. G06K 9/00

(52) U.S. Cl. 382/141

(57) ABSTRACT

A device for estimating a surface area of a defect in a coating on a gas turbine engine component comprises a thin transparent sheet and at least one template included on the sheet and having a known surface area. The device is configured such that the template can be positioned over the defect to allow a user to estimate the surface area of the defect by comparing a size and shape of the defect to a size and shape of the template.

### STATEMENT OF GOVERNMENT INTEREST

The U.S. Government has a paid-up license in this invention and the right in limited circumstances to require the patent owner to license others on reasonable terms as provided for by the terms of F33657-99-D-2051 awarded by the Air Force.

### BACKGROUND

The present invention relates to surface area estimation of a coating defect. More specifically, the present invention is a device and method for quickly and easily estimating the surface area of a coating defect on a gas turbine engine component.

Gas turbine engines operate under extremely high heat. For protection from the rigorous operating conditions, a thermal barrier coating is applied to the surface of gas turbine components. While gas turbine components are generally designed to withstand high levels of thermal stress, under certain circumstances defects may still develop in the surface coating of these components. Therefore, once an engine is put into service, maintenance inspections are scheduled at specific time intervals to evaluate the number and size of coating defects present on each component. Standards exist which specify the maximum amount of allowable coating loss for each particular component and surface. As such, the surface area of each coating defect must be determined and recorded.

Standard measurement and calculation techniques are generally employed to determine the surface area of each coating defect present. Physical measurements of the length and width or the diameter of each defect is taken. The appropriate geometric equation or equations are then applied to calculate the surface area of the defect (i.e. the amount of coating loss).

### SUMMARY

The present invention is a device for estimating a surface area of a defect in a coating on a gas turbine engine component, which comprises a thin transparent sheet and at least one template included on the sheet and having a pre-calculated surface area. The device is configured such that the template can be positioned over the defect to allow a user to estimate the surface area of the defect by comparing a size and shape of the defect to a size and shape of the template.

To estimate the surface area, the component is first visually inspected to identify the location of the defect. The general shape and size of the defect is then assessed. A template is selected that most closely corresponds to the shape and size of the defect by positioning the template over the defect to evaluate how well the template corresponds to the defect. The surface area of the defect may then be estimated by referencing the pre-calculated surface area of the selected corresponding template.

### BRIEF DESCRIPTION OF THE DRAWINGS

FIG. 1 is a flow diagram illustrating a method for estimating a surface area of a defect in a coating on a gas turbine engine component.

FIGS. 2A-2E illustrate exemplary embodiments of a surface area estimation device.

FIG. 3 illustrates the use of a surface area estimation device to estimate the surface area of a coating defect.

### DETAILED DESCRIPTION

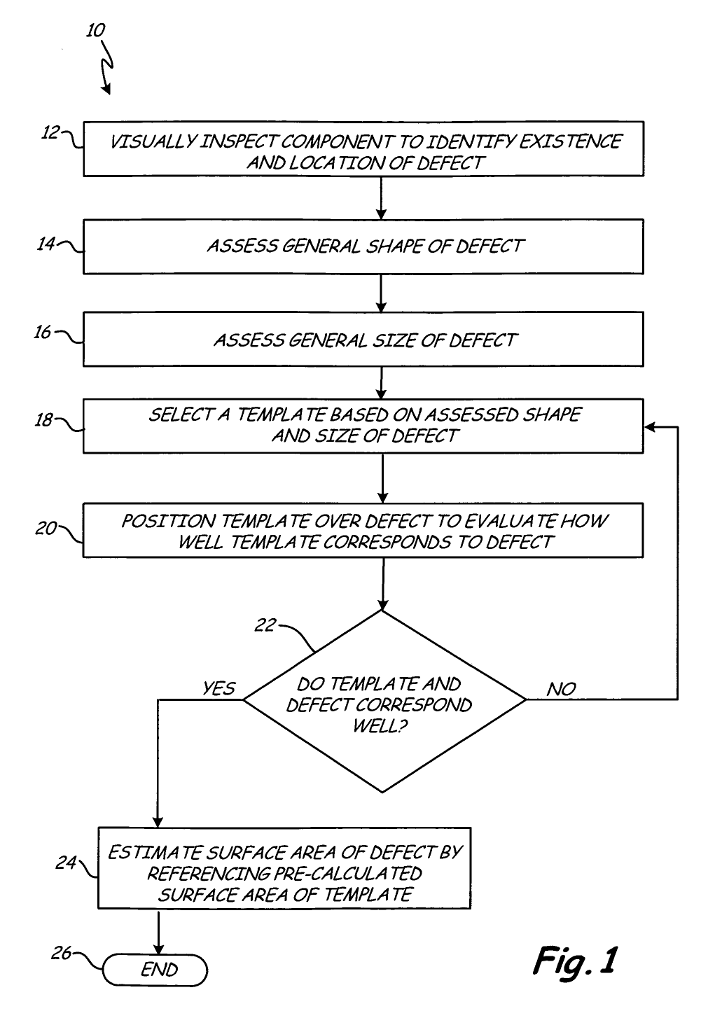

FIG. 1 is a flow diagram of method 10 for estimating a surface area of a defect in a coating on a gas turbine engine component. As discussed above, gas turbine engines are periodically inspected to determine the amount of coating loss that has occurred during operation. In order to calculate the total amount of coating loss, the surface area of all existing coating defects must be determined. Measuring each individual coating defect and applying the appropriate geometric equation or equations is time-consuming. This is especially true for engines that have been in service for a long period of time, as many coating defects may be present. Therefore, there is a need in the art for a method of quickly and reliably estimating the surface area of such defects.

Method 10 includes steps 12-26 and initially involves visually inspecting a gas turbine engine component to identify the location of the coating defect (step 12). Once a coating defect and its location is identified, the general shape of the defect must be assessed (step 14). For example, in an exemplary embodiment, it must be determined whether the defect is generally circular, square, rectangular, triangular or elliptical. When the general shape of the defect is determined, the general size of the defect is assessed (step 16). In general, coating defects on gas turbine engine components typically range from about 0.1 square inches (0.65 cm²) to about 10 square inches (64.52 cm²).

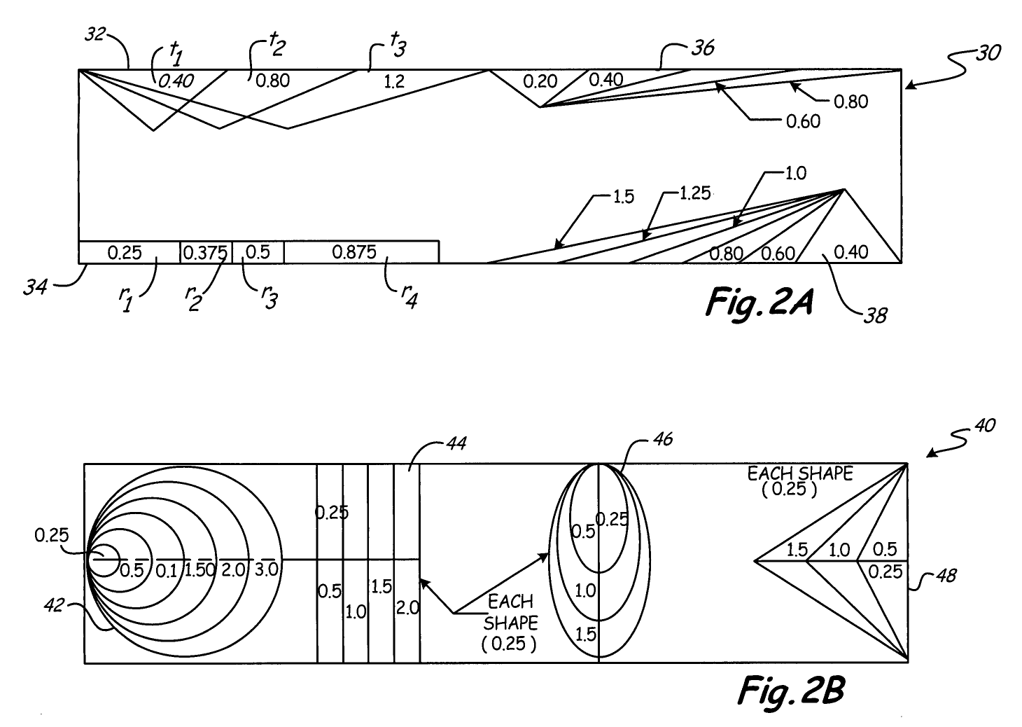

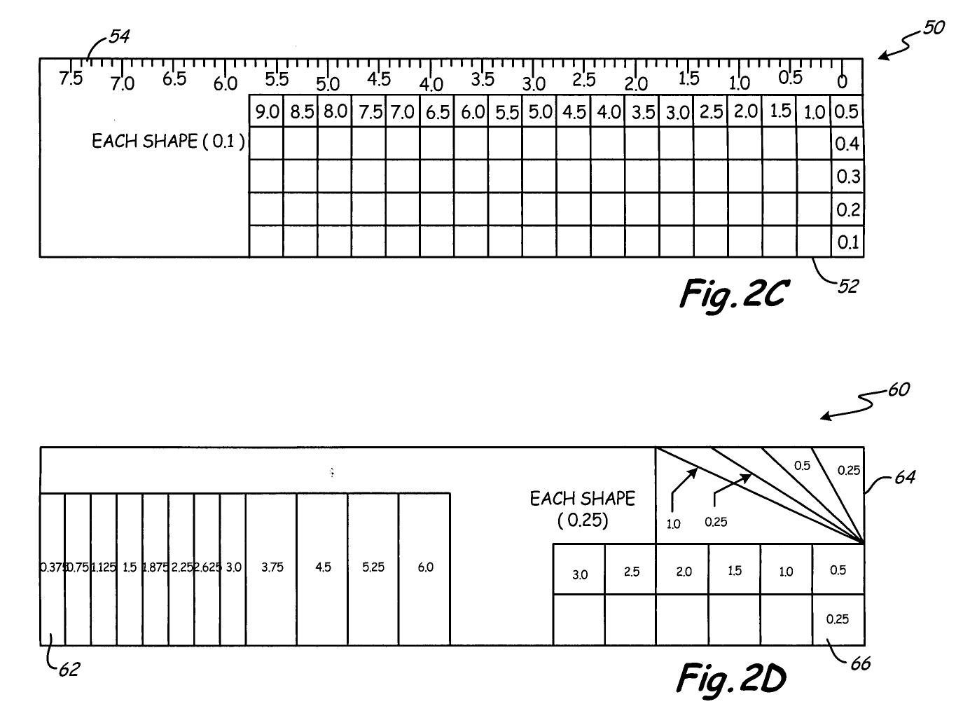

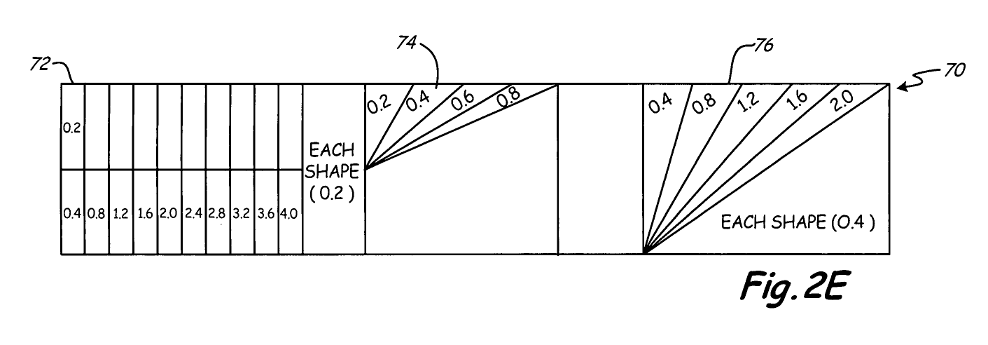

Next, a template is selected that most closely corresponds to the determined shape and size of the defect (step 18). The template is located on a surface area estimation device. (The surface area estimation device is described in detail with reference to FIGS. 2A-2E.) In an exemplary embodiment, the surface area estimation device (or devices) includes multiple templates of varying shapes and sizes. Each template has a pre-calculated surface area that may be recorded on the device. The device is placed on the component and the selected template is positioned over the defect (step 20). A comparison is then performed to assess how closely the shape and size of the template correspond to the shape and size of the defect (step 22). If the template and defect do not appear to correspond to each other very well, step 18 is repeated. A new template is selected based on the assessed size and shape of the defect. The new template is positioned over the defect and the same evaluation is performed. Steps 18-20 may be repeated as many times as necessary until the best corresponding template is found. Once the template and defect appear to be adequately matched, the appropriate template has been selected.

When it is determined that the template which most closely corresponds to the size and shape of the template has been selected, the surface of the defect is estimated by referencing the pre-calculated surface area of the template (step 24). As mentioned above, the pre-calculated surface area may be recorded directly on the device. However, the invention is not so limited and the pre-calculated surface area may also be recorded in any suitable matter, such as on a separate reference paper.

FIGS. 2A-2E illustrate exemplary embodiments of surface area estimation device 30, 40, 50, 60 and 70. Each surface area estimation device 30, 40, 50, 60 and 70 is comprised of a thin sheet of transparent material having various geometric shapes printed on it. In the exemplary embodiments shown, each surface area estimation device 30, 40, 50, 60 and 70 is comprised of plastic and has a height of about 2 inches (5.08 cm) and a length of about 8 inches (20.3 cm). However, the invention is not so limited and surface area estimation device 30, 40, 50, 60 and 70 may be any desired size and be comprised of any suitable transparent material.

As mentioned above, each surface area estimation device 30, 40, 50, 60 and 70 is printed with a number of geometric shapes or templates. These shapes generally correspond with possible geometric shapes made by defects which may be observed in the coating layer of an engine component. In the exemplary embodiments shown, circular, square, rectangular, triangular or elliptical shapes are included. However, the invention is not so limited and any geometric shape may be included. Additionally, each geometric shape is divided into numerous sections. This is so that each shape is sized to generally correspond with possibly sizes of observed coating defects. Each section of each template is printed with its pre-calculated surface area so the pre-calculated surface area may be easy referenced at any time. As shown in FIGS. 2A-2E, the pre-calculated surface areas are recorded in square centimeters. However, the invention is not so limited and a surface area estimation device may also be printed with numerical values representing pre-calculated surface areas recorded in metric units as opposed to standard units.

In this way, when a coating defect is identified, a template may be selected from surface area estimation device 30, 40, 50, 60 and 70 that mostly closely corresponds to the actual shape and size of the coating defect. As described with respect to FIG. 1, the appropriate template is selected by placing surface area estimation device 30, 40, 50, 60 and 70 over the defect and comparing how closely the shape and size of the template correspond to the shape and size of the defect. Various templates may be evaluated until the best match is found. The surface of the defect may then be estimated by referencing the pre-calculated surface area of the selected template.

FIG. 2A illustrates a first exemplary embodiment of surface area estimation device 30, which includes four templates 32, 34, 36, 38. Template 32 is generally triangular and is divided into three graduated sections t₁, t₂ and t₃. As shown, t₁ has a pre-calculated surface area of 0.40 square inches (2.58 cm²), t₂ has a pre-calculated surface area of 0.80 square inches (5.16 cm²) and t₃ has a pre-calculated surface area of 1.2 square inches (7.74 cm²). Template 32 may be used for estimating the surface area of a coating defect having a similar generally triangular shape. After it is determined that the overall shape of the identified coating defect best corresponds to the triangular shape of template 32, it must be determined which section (i.e. t₁, t₂ or t₃) best corresponds to the overall size of the coating defect. (As described above, the determination of the best corresponding shape and size may be conducted by placing surface area estimation device 30 over the coating defect for performing a comparison.) Once the best match is made, the surface area of the coating defect may be easily estimated by referencing the pre-calculated surface area printed on surface area estimation device 30. For example, if it is determined that t₁ best matches the overall shape and size of the defect, a conclusion can be made that the surface area of the defect is about 0.40 square inches (2.58 cm²).

In addition, surface area estimation device 30 includes template 34, which is generally rectangular and is divided into four sections r₁, r₂, r₃ and r₄. As shown, r₁, has a pre-calculated surface area of 0.25 square inches (1.61 cm²), r₂ has a pre-calculated surface area of 0.375 square inches (2.42 cm²), r₃ has a pre-calculated surface area of 0.5 square inches (3.23 cm²) and r₄ has a pre-calculated surface area of 0.875 square inches (5.65 cm²). Template 34 is separated into four sections, which divide up template 32 as a whole. The surface area of each section is cumulative. Therefore, r₂ has a pre-calculated surface area of 0.375 square inches (2.42 cm²) because it also includes the surface area of r₁. Similarly, r₃ has a pre-calculated surface area of 0.5 square inches (3.23 cm²) because it also includes the surface areas of both r₁ and r₂. Finally, r₄ has a pre-calculated surface area of 0.875 square inches (5.65 cm²) and also includes the surface areas of r₁, r₂ and r₃. Template 34 may be used for estimating the surface area of a coating defect having a similar generally rectangular shape. After it is determined, that the overall shape of the identified coating defect best corresponds to the rectangular shape of template 34, it must be determined which section or sections (i.e. r₁, r₂, r₃ or r₄) best corresponds to the overall size of the coating defect. Once the best match is made, the surface area of the coating defect may be easily estimated by referencing the pre-calculated surface area printed on surface area estimation device 30. For example, if it is determined that r₃ best matches the overall shape and size of the defect, a conclusion can be made that the surface area of the defect is about 0.5 square inches (3.23 cm²).

Surface area estimation device 30 also includes templates 36 and 38, which are both generally triangular. Template 36 is separated into four sections, which divide the total 0.80 square inch surface area (5.16 cm²) of template 36 evenly, so each section has a surface area of 0.20 square inches (1.29 cm²). As shown, template 38 is divided into six sections surface areas with each section having a surface area of either 0.2 (1.29 cm²) or 0.25 square inches (1.61 cm²). As such template 38 has a total surface area of 1.5 square inches (9.68 cm²). Templates 36 and 38 may be used in a similar way as described in detail above with respect to template 34.

FIG. 2B illustrates a second exemplary embodiment of surface area estimation device 40, which includes four templates 42, 44, 46, 48. Template 42 is generally circular and has a total surface area of 3.0 square inches (19.35 cm²). Template 42 is separated into six sections, which divide up the total surface area of template 42. Template 44 is generally rectangular and is divided into eight sections equally sized sections. Each section of template 44 has a surface area of 0.25 square inches (1.61 cm²) so template 44 has a total surface area of 2.0 square inches (12.90 cm²). Template 46 is generally elliptical and is divided into six equally sized sections, each section having a surface area of 0.25 square inches (1.61 cm²). Similarly, template 48 is generally triangular and is divided into six equally sized sections, each section having a surface area of 0.25 square inches (1.61 cm²). As such, both template 44 and template 46 have a total surface area of 1.5 square inches (9.68 cm²). Templates 42, 44, 46, 48 may be used in a similar way as described in detail above with respect to template 34.

FIG. 2C illustrates a third exemplary embodiment of surface area estimation device 50, which includes template 52. Template 52 is generally rectangular and is divided into 90 equally sized sections. Each section is square-shaped and has a surface area of 0.1 square inches (0.65 cm²). As such, template 52 has a total surface area of 9.0 square inches (58.06 cm²). Template 52 may be used in a similar way as described in detail above with respect to template 34. Therefore, because of the design of template 52, it can be used to estimate the surface area of coating defects having numerous shapes and sizes. In addition, template 52 also includes ruler 54 along one edge. Ruler 54 may be used to measure a coating defect when the use of traditional calculation methods is desired.

FIG. 2D illustrates a fourth exemplary embodiment of surface area estimation device 60, which includes three templates 62, 64, 66. As shown, template 62 is generally rectangular and has a total surface area of 6.0 square inches (38.71 cm²). Template 62 is divided into 12 sections, which divide up the total surface area of template 62. Template 64 is generally triangular and is divided into three sections. Each section has a surface area of 0.25 square inches (1.61 cm²). Template 66 is generally rectangular and has a total surface area of 3.0 square inches (19.35 cm²). Template 66 is separated into 12 sections, which each have a surface area of 0.25 square inches (1.61 cm²). Templates 62, 64, 66 may be used in a similar way as described in detail above with respect to template 34.

FIG. 2E illustrates a fifth exemplary embodiment of surface area estimation device 70, which includes three templates 72, 74, 76. As shown, template 72 is generally rectangular and has a total surface area of 4.0 square inches (25.81 cm²). Template 72 is divided into 20 sections, which divide up the total surface area of template 72 into equal sections having a surface area of 0.2 square inches (1.29 cm²). Template 74 is generally triangular and is divided into four sections. Each section has a surface area of 0.20 square inches (0.51 cm²). Template 76 is also generally triangular and has a total surface area of 2.0 square inches (12.90 cm²). Template 66 is separated into five sections, which each have a surface area of 0.40 square inches (2.58 cm²). Templates 72, 74, 76 may be used in a similar way as described in detail above with respect to template 34.

The use of surface area estimation device 30, 40, 50, 60 and 70 allows for quick and easy estimation of the surface area of a coating defect on a gas turbine engine component. As described above, templates having numerous shapes and/or sizes are provided. In addition, other sized and shaped templates may also be used in a similar manner. In addition, it may also be possible to combine the pre-calculated surface areas of multiple templates or sections of multiple templates to most accurately estimate the surface area of a given coating defect.

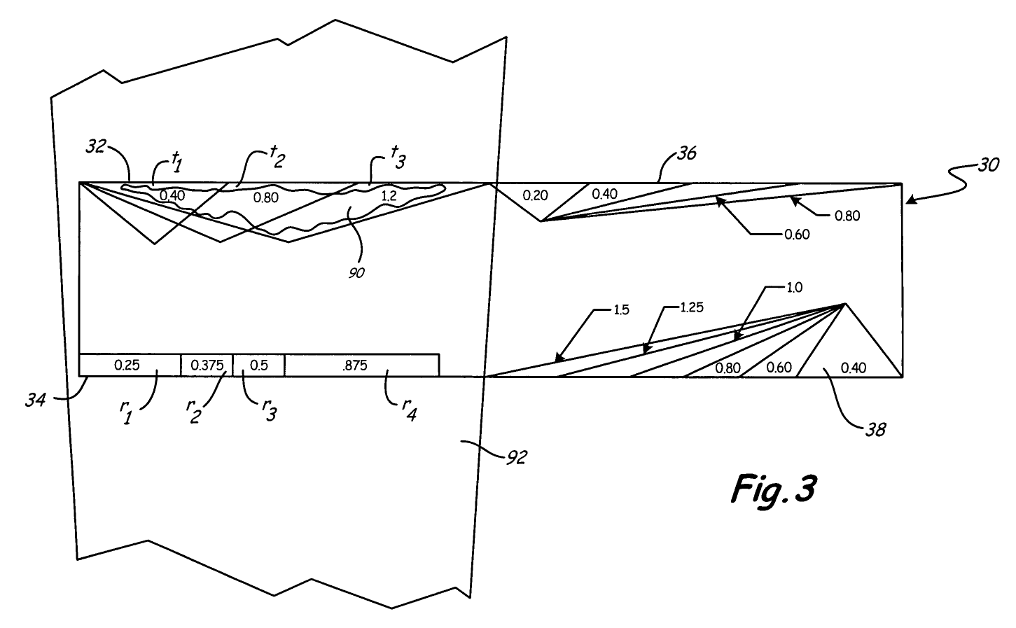

FIG. 3 illustrates the use of surface area estimation device 30 to estimate the surface area of coating defect 90. Also shown is the surface of component 92 on which coating defect 90 is located. Surface area estimation device 30 is shown resting on a top surface of component 92 in the location of coating defect 90. However, since surface area estimation device 30 is comprised of a thin sheet of transparent material, coating defect may be seen through surface area estimation device 30. In this way both the size and shape of coating defect 90 can been assessed and an evaluation of how well each template corresponds to the overall size and shape of coating defect 90 can be made. In the exemplary embodiment shown in FIG. 3, it can be determined that the size and shape of section t₃ of template 32 best corresponds to the overall size and shape of coating defect 90. As a result, the surface area of coating defect 90 can be estimated by referencing the per-calculated surface area of section t₃ of template 32. Therefore, the estimated surface area of coating defect 90 is 1.2 square centimeters (7.74 cm²).

Although the present invention has been described with reference to preferred embodiments, workers skilled in the art will recognize that changes may be made in form and detail without departing from the spirit and scope of the invention.

1. A device comprising:
a thin transparent sheet;
at least one template included on the sheet; and
a pre-calculated surface area on each template;
wherein the surface area of a defect on a gas turbine engine component is estimated by comparing the size and shape of the defect to the size and shape of the pre-calculated surface area.

2. The device of claim 1 wherein the shape of the defect and the shape of the template are generally similar.

3. The device of claim 1 wherein the size of the defect and the shape of the template are generally similar.

4. The device of claim 1 wherein the template has a generally circular shape.

5. The device of claim 5 wherein the template has a surface area of about 1.61 cm² to about 19.35 cm².

6. The device of claim 1 wherein the template has a generally rectangular shape.

7. The device of claim 6 wherein the template has a surface area of about 1.61 cm² to about 58.06 cm².

8. The device of claim 1 wherein the template has a generally triangular shape.

9. The device of claim 8 wherein the template has a surface area of about 1.29 cm² to about 12.90 cm².

10. The device of claim 1 wherein the template has a generally elliptical shape.

11. The device of claim 10 wherein the template has a surface area of about 3.23 cm² to about 9.68 cm².

12. The device of claim 1 further comprising:
a plurality of templates included on the body, each template comprising a shape having a pre-calculated surface area.

13. The device of claim 12 wherein each template has a different shape.

14. The device of claim 12 wherein each template has a similar shape.

15. The device of claim 14 wherein each template has a different size.

16. A device comprising:
a thin transparent sheet;
at least one template included on the sheet and having a size and a shape; and
a numerical value representing a pre-calculated surface area of the template positioned on the sheet in association with the template;
wherein the template can be positioned over a defect on a gas turbine engine component having a generally similar size and shape to allow a user to estimate the surface area of the defect by referencing the numerical value representing the calculated surface area of the template.

17. The device of claim 16 wherein the shape of the template is selecting from the group consisting of a circle, a square, a rectangle, a triangle, and an ellipsis.

18. The device of claim 16 wherein the size of the template ranges from about 0.65 cm² to about 64.52 cm².

19. A method comprising:
visually inspecting a gas turbine engine component to identify the existence and location of a defect;
assessing a general shape of the defect;
assessing a general size of the defect;
selecting a template included on a transparent surface area estimation tool and having a pre-calculated surface area that most closely corresponds to the shape and size of the defect;
positioning the template over the defect to evaluate how well the template corresponds to the defect; and
estimating the surface area of the defect by referencing the pre-calculated surface area of the selected corresponding template.
